(19) United States
(12) Patent Application Publication
(10) Pub. No.: US 2025/0261182 A1
(43) Pub. Date: Aug. 14, 2025

(54) METHODS AND APPARATUSES FOR CONFIGURED GRANT (CG) CONFIGURATIONS IN A FULL DUPLEX SYSTEM

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Zhi Yan, Beijing (CN); Haiming Wang, Beijing (CN)

(73) Assignee: Lenovo (Beijing) Limited, Beijing (CN)

(21) Appl. No.: 18/992,396

(22) PCT Filed: Jul. 8, 2022
(86) PCT No.: PCT/CN2022/104693

§ 371 Date: Jan. 8, 2025

(51) Int. Cl. H04W 72/115; H04L 5/00; H04L 27/26

(52) U.S. Cl. CPC H04W 72/115; H04L 5/0044; H04L 27/2607

(57) ABSTRACT

Embodiments of the present disclosure relate to methods and apparatuses for configured grant (CG) configuration in a full duplex (FD) system. According to some embodiments of the present disclosure, a user equipment (UE) may include: a transceiver configured to receive a first CG configuration for an uplink (UL) bandwidth part (BWP); and receive a second CG configuration for a UL subband, wherein the first CG configuration and the second CG configuration are received in first signaling; or wherein the first CG configuration is received in second signaling and the second CG configuration is received in third signaling different from the second signaling; and a processor coupled to the transceiver.

### TECHNICAL FIELD

Embodiments of the present disclosure generally relate to wireless communication technology, and more particularly to methods and apparatuses for a configured grant (CG) configuration(s) in a full duplex (FD) system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time. Details regarding CG configuration in a full duplex system need to be studied.

### SUMMARY

Some embodiments of the present disclosure provide a user equipment (UE). The UE may include: a transceiver configured to: receive a first CG configuration for an uplink (UL) bandwidth part (BWP); and receive a second CG configuration for a UL subband, wherein the first CG configuration and the second CG configuration are received in first signaling; or wherein the first CG configuration is received in second signaling and the second CG configuration is received in third signaling different from the second signaling; and a processor coupled to the transceiver.

In some embodiments of the present disclosure, in the case that the first CG configuration and the second CG configuration are received in the first signaling, a type of CG configured by the first CG configuration and a type of CG configured by the second CG configuration are different.

In some embodiments of the present disclosure, the first CG configuration configures a type 1 CG for the UL BWP, and the second CG configuration configures a type 2 CG for the UL subband; and wherein the transceiver is further configured to: receive first downlink control information (DCI) for CG activation, wherein the first DCI only activates the type 2 CG for the UL subband; or receive a second DCI for CG deactivation, wherein the second DCI only deactivates the type 2 CG for the UL subband.

In some embodiments of the present disclosure, in the case that the first CG configuration and the second CG configuration are received in the first signaling, a type of CG configured by the first CG configuration and a type of CG configured by the second CG configuration are the same.

In some embodiments of the present disclosure, wherein the first CG configuration configures a type 2 CG for the UL BWP, and the second CG configuration configures a type 2 CG for the UL subband; and wherein the transceiver is further configured to receive first DCI for CG activation, wherein the first DCI includes an indication indicating to activate the type 2 CG for the UL BWP, the type 2 CG for the UL subband, or both the type 2 CG for the UL BWP and the type 2 CG for the UL BWP, or wherein a cyclic redundancy check (CRC) of the first DCI is scrambled by a radio network temporary identifier (RNTI), and whether the type 2 CG for the UL BWP or the type 2 CG for the UL subband is activated by the first DCI is determined based on the RNTI; or wherein the transceiver is further configured to receive second DCI for CG deactivation, wherein the second DCI includes an indication indicating to deactivate the type 2 CG for the UL BWP, the type 2 CG for the UL subband, or both the type 2 CG for the UL BWP and the type 2 CG for the UL BWP, or wherein a CRC of the second DCI is scrambled by an RNTI, and whether the type 2 CG for the UL BWP or the type 2 CG for the UL subband is deactivated by the second DCI is determined based on the RNTI.

In some embodiments of the present disclosure, the first CG configuration configures a type 1 CG for the UL BWP, and the second CG configuration configures a type 1 CG for the UL subband.

In some embodiments of the present disclosure, the first CG configuration configures a type 2 CG for the UL BWP, and the second CG configuration configures a type 1 CG for the UL subband; and wherein the transceiver is further configured to: receive first DCI for CG activation, wherein the first DCI only activates the type 2 CG for the UL BWP; or receive a second DCI for CG deactivation, wherein the second DCI only deactivates the type 2 CG for the UL BWP.

In some embodiments of the present disclosure, the second CG configuration shares at least one of the following parameters with the first CG configuration: a first set of parameters for determining time units including CG resources; or a second set of parameters for physical uplink shared channel (PUSCH) repetition.

In some embodiments of the present disclosure, the processor is further configured to determine a time unit including CG resources based on the first set of parameters, in the case that the time unit is a downlink (DL) time unit with the UL subband, CG resources for the UL subband determined based on the second CG configuration is available for a PUSCH transmission; and in the case that the time unit is a UL time unit, CG resources for the UL BWP determined based on the first CG configuration is available for a PUSCH transmission.

In some embodiments of the present disclosure, in the case that the second CG configuration shares the second set of parameters for PUSCH repetition with the first CG configuration, the processor is further configured to perform a PUSCH repetition between CG resources for the UL subband determined based on the second CG configuration and CG resources for the UL BWP determined based on the first CG configuration.

In some embodiments of the present disclosure, in the case that the first CG configuration is received in a second signaling and the second CG configuration is received in a third signaling, the first CG configuration is associated with the second CG configuration.

In some embodiments of the present disclosure, an association of the first CG configuration and the second CG configuration is indicated in the third signaling.

In some embodiments of the present disclosure, the association of the first CG configuration and the second CG configuration is based on an index of the first CG configuration and an index of the second CG configuration.

In some embodiments of the present disclosure, the transceiver is further configured to receive a first list of CG configurations for the UL BWP each with an index and a second list of CG configurations for the UL subband each with an index, and wherein a CG configuration in the first list is associated with a CG configuration in the second list when they have the same index.

In some embodiments of the present disclosure, the processor is further configured to determine a first set of time units with CG resources for the UL BWP based on the first CG configuration and a second set of time units with CG resources for the UL subband based on the second configuration.

In some embodiments of the present disclosure, in the case that both the first set of time units and the second set of time units include a first time unit: the processor is further configured to determine CG resources for the UL subband are available for a PUSCH transmission in the first time unit when CG resources for the UL BWP are not within the UL subband in the first time unit; or whether CG resources for the UL subband or CG resources for the UL BWP are available for a PUSCH transmission in the first time unit is configured or preconfigured when CG resources for the UL BWP are within the UL subband in the first time unit.

In some embodiments of the present disclosure, the processor is further configured to perform a PUSCH repetition in a time unit(s) of the second set of time units with available CG resources for the UL BWP and a time unit(s) the second set of time units with available CG resources for the UL subband when the PUSCH repetition is configured for the UE.

In some embodiments of the present disclosure, the first CG configuration includes at least one parameter which is not included in the second CG configuration but is applicable for the second CG configuration.

In some embodiments of the present disclosure, the at least one parameter includes one or more of the following: a first set of parameters for determining time units including CG resources; or a second set of parameters for PUSCH repetition.

In some embodiments of the present disclosure, the processor is further configured to determine a time unit based on the first set of parameters, and in the case that the time unit is configured with the UL subband, CG resources for the UL subband determined based on the second configuration are available for a PUSCH transmission in the time unit.

In some embodiments of the present disclosure, in the case that the first CG configuration is received in a second signaling and the second CG configuration is received in a third signaling, the first CG configuration is not associated with the second CG configuration.

In some embodiments of the present disclosure, the third signaling indicates that the second CG configuration is specific for a CG for the UL subband.

In some embodiments of the present disclosure, the processor is further configured to determine a time unit based on the first CG configuration, in the case that the time unit is a DL time unit configured with the UL subband, CG resources for the UL BWP determined based on the first configuration are not available in the DL time unit; or wherein the processor is further configured to determine a time unit based on the second CG configuration, in the case that the time unit is a UL time unit, CG resources for the UL subband determined based on the second configuration are not available in the UL time unit.

In some embodiments of the present disclosure, the processor is further configured to perform a PUSCH repetition in a set of UL time units with CG resources for the UL BWP determined based on the first CG configuration or in a set of DL time units with CG resources for the UL subband determined based on the second CG configuration when the PUSCH repetition is configured for the UE.

Some embodiments of the present disclosure provide a base station (BS). The BS may include: a transceiver configured to: transmit, to a UE, a first CG configuration for a UL BWP; and transmit, to the UE, a second CG configuration for a UL subband, wherein the first CG configuration and the second CG configuration are transmitted in first signaling; or wherein the first CG configuration is transmitted in second signaling and the second CG configuration is transmitted in third signaling different from the second signaling; and a processor coupled to the transceiver.

In some embodiments of the present disclosure, in the case that the first CG configuration and the second CG configuration are received in the first signaling, a type of CG configured by the first CG configuration and a type of CG configured by the second CG configuration are different.

In some embodiments of the present disclosure, the first CG configuration configures a type 1 CG for the UL BWP, and the second CG configuration configures a type 2 CG for the UL subband, and wherein the transceiver is further configured to: transmit first DCI for CG activation, wherein the first DCI only activates the type 2 CG for the UL subband; or transmit a second DCI for CG deactivation, wherein the second DCI only deactivates the type 2 CG for the UL subband.

In some embodiments of the present disclosure, in the case that the first CG configuration and the second CG configuration are received in the first signaling, a type of CG configured by the first CG configuration and a type of CG configured by the second CG configuration are the same.

In some embodiments of the present disclosure, the first CG configuration configures a type 2 CG for the UL BWP, and the second CG configuration configures a type 2 CG for the UL subband; and the transceiver is further configured to transmit first DCI for CG activation, the first DCI includes an indication indicating to activate the type 2 CG for the UL BWP, the type 2 CG for the UL subband, or both the type 2 CG for the UL BWP and the type 2 CG for the UL BWP, or a CRC of the first DCI is scrambled by an RNTI, and whether the type 2 CG for the UL BWP or the type 2 CG for the UL subband is activated by the first DCI is determined based on the RNTI; or the transceiver is further configured to transmit second DCI for CG deactivation, the second DCI includes an indication indicating to deactivate the type 2 CG for the UL BWP, the type 2 CG for the UL subband, or both the type 2 CG for the UL BWP and the type 2 CG for the UL BWP, or a CRC of the second DCI is scrambled by an RNTI, and whether the type 2 CG for the UL BWP or the type 2 CG for the UL subband is deactivated by the second DCI is determined based on the RNTI.

In some embodiments of the present disclosure, the first CG configuration configures a type 1 CG for the UL BWP, and the second CG configuration configures a type 1 CG for the UL subband.

In some embodiments of the present disclosure, the first CG configuration configures a type 2 CG for the UL BWP, and the second CG configuration configures a type 1 CG for the UL subband, wherein the transceiver is further configured to: transmit first DCI for CG activation, wherein the first DCI only activates the type 2 CG for the UL BWP; or transmit a second DCI for CG deactivation, wherein the second DCI only deactivates the type 2 CG for the UL BWP.

In some embodiments of the present disclosure, the second CG configuration shares at least one of the following parameters with the first CG configuration: a first set of parameters for determining time units including CG resources; or a second set of parameters for PUSCH repetition.

In some embodiments of the present disclosure, the processor is further configured to determine a time unit including CG resources based on the first set of parameters, in the case that the time unit is a DL time unit with the UL subband, CG resources for the UL subband determined based on the second CG configuration is available for a PUSCH transmission; and in the case that the time unit is a UL time unit, CG resources for the UL BWP determined based on the first CG configuration is available for a PUSCH transmission.

In some embodiments of the present disclosure, in the case that the second CG configuration shares the second set of parameters for PUSCH repetition with the first CG configuration, the processor is further configured to receive a PUSCH repetition between CG resources for the UL subband determined based on the second CG configuration and CG resources for the UL BWP determined based on the first CG configuration.

In some embodiments of the present disclosure, in the case that the first CG configuration is transmitted in a second signaling and the second CG configuration is transmitted in a third signaling, the first CG configuration is associated with the second CG configuration.

In some embodiments of the present disclosure, an association of the first CG configuration and the second CG configuration is indicated in the third signaling.

In some embodiments of the present disclosure, the association of the first CG configuration and the second CG configuration is based on an index of the first CG configuration and an index of the second CG configuration.

In some embodiments of the present disclosure, the transceiver is further configured to transmit a first list of CG configurations for the UL BWP each with an index and a second list of CG configurations for the UL subband each with an index, and wherein a CG configuration in the first list is associated with a CG configuration in the second list when they have the same index.

In some embodiments of the present disclosure, the processor is further configured to determine a first set of time units with CG resources for the UL BWP based on the first CG configuration and a second set of time units with CG resources for the UL subband based on the second configuration.

In some embodiments of the present disclosure, in the case that both the first set of time units and the second set of time units include a first time unit: the processor is further configured to determine CG resources for the UL subband are available for a PUSCH transmission in the first time unit when CG resources for the UL BWP are not within the UL subband in the first time unit; or the transceiver is further configured to transmit, to the UE, a configuration indicating whether CG resources for the UL subband or CG resources for the UL BWP are available for a PUSCH transmission in the first time unit when CG resources for the UL BWP are within the UL subband in the first time unit; or whether CG resources for the UL subband or CG resources for the UL BWP are available for a PUSCH transmission in the first time unit is preconfigured when CG resources for the UL BWP are within the UL subband in the first time unit.

In some embodiments of the present disclosure, the processor is further configured to receive a PUSCH repetition in a time unit(s) of the second set of time units with available CG resources for the UL BWP and a time unit(s) of the second set of time units with available CG resources for the UL subband when the PUSCH repetition is configured for the UE.

In some embodiments of the present disclosure, the first CG configuration includes at least one parameter which is not included in the second CG configuration but is applicable for the second CG configuration.

In some embodiments of the present disclosure, the at least one parameter includes one or more of the following: a first set of parameters for determining time units including CG resources; or a second set of parameters for PUSCH repetition.

In some embodiments of the present disclosure, the processor is further configured to determine a time unit based on the first set of parameters, and in the case that the time unit is configured with the UL subband, CG resources for the UL subband determined based on the second configuration are available for a PUSCH transmission in the time unit.

In some embodiments of the present disclosure, in the case that the first CG configuration is transmitted in a second signaling and the second CG configuration is transmitted in a third signaling, the first CG configuration is not associated with the second CG configuration.

In some embodiments of the present disclosure, the third signaling indicates that the second CG configuration is specific for a CG for the UL subband.

In some embodiments of the present disclosure, the processor is further configured to determine a time unit based on the first CG configuration, in the case that the time unit is a DL time unit configured with the UL subband, CG resources for the UL BWP determined based on the first configuration are not available in the DL time unit; or the processor is further configured to determine a time unit based on the second CG configuration, in the case that the time unit is a UL time unit, CG resources for the UL subband determined based on the second configuration are not available in the UL time unit.

In some embodiments of the present disclosure, the processor is further configured to receive a PUSCH repetition in a set of UL time units with CG resources for the UL BWP determined based on the first CG configuration or in a set of DL time units with CG resources for the UL subband determined based on the second CG configuration when the PUSCH repetition is configured for the UE.

Some embodiments of the present disclosure provide a method performed by a UE. The method may include: receiving a first CG configuration for a UL BWP; and receiving a second CG configuration for a UL subband, wherein the first CG configuration and the second CG configuration are received in first signaling; or wherein the first CG configuration is received in second signaling and the second CG configuration is received in third signaling different from the second signaling.

Some embodiments of the present disclosure provide a method performed by a BS. The method may include: transmitting, to a UE, a first CG configuration for a UL BWP; and transmitting, to the UE, a second CG configuration for a UL subband, wherein the first CG configuration and the second CG configuration are transmitted in first signaling; or wherein the first CG configuration is transmitted in second signaling and the second CG configuration is transmitted in third signaling different from the second signaling.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure;

FIG. 2 illustrates exemplary duplex modes according to some embodiments of the present disclosure;

FIG. 3 illustrates exemplary radio resources in a time division duplex (TDD) system according to some embodiments of the present disclosure;

FIG. 4(a) illustrates an exemplary method for activating and deactivating type 1 CG according to some embodiments of the present disclosure;

FIG. 4(b) illustrates an exemplary method for activating and deactivating type 2 CG according to some embodiments of the present disclosure;

FIG. 5 illustrates exemplary CG configurations for different traffic needs according to some embodiments of the present disclosure;

FIG. 6 illustrates exemplary CG configurations for latency reduction according to some embodiments of the present disclosure;

FIG. 7 illustrates an exemplary CG configuration for a UL subband and a CG configuration for a UL BWP according to some embodiments of the present disclosure;

FIG. 8 is a flow chart illustrating an exemplary method for a CG configuration in a full duplex system according to some embodiments of the present disclosure;

FIG. 9 illustrates an exemplary PUSCH repetition among CG resources of a CG for a subband and CG resources for a BWP according to some embodiments of the present disclosure.

FIG. 10 illustrates an exemplary method for performing a PUSCH repetition according to some embodiments of the present disclosure;

FIG. 11 is a flow chart illustrating an exemplary method for a CG configuration in a full duplex system according to some other embodiments of the present disclosure; and

FIG. 12 illustrates a simplified block diagram of an exemplary apparatus for a CG configuration in a full duplex system according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

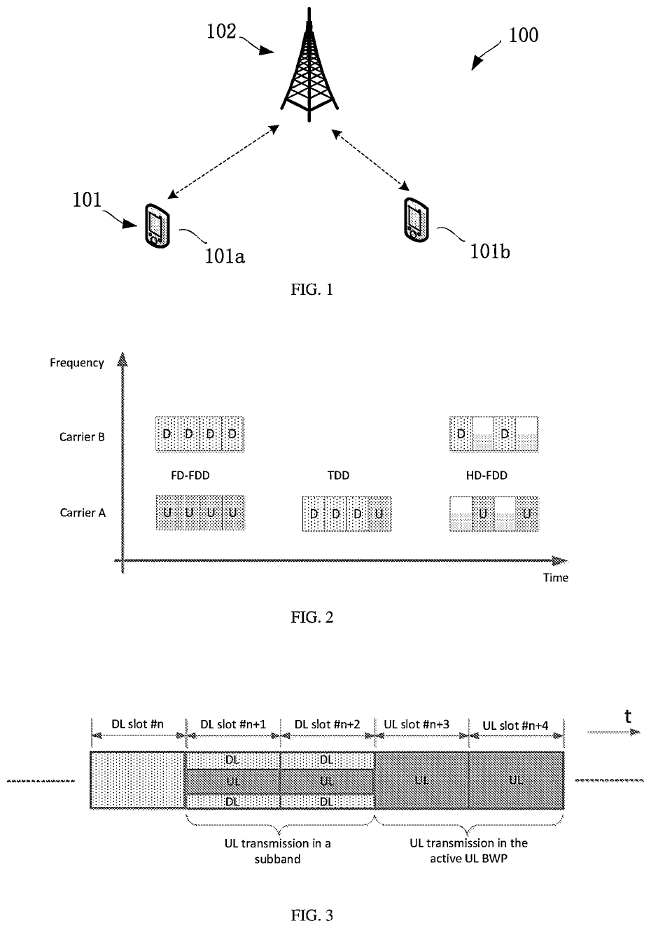

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a BS (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via UL communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via DL communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time.

FIG. 2 illustrates exemplary duplex modes according to some embodiments of the present disclosure.

Referring to FIG. 2, duplex modes may include, for example, a full duplex frequency division duplex (FD-FDD) mode, a TDD mode, and a half duplex frequency division duplex (HD-FDD) mode.

In some examples, in a full duplex transceiver, different carrier frequencies (e.g., carrier A and carrier B) may be employed for transmissions in each link direction, for example, carrier A may be used for the uplink transmissions while carrier B may be used for the downlink transmissions. Such kind of full duplex may be referred to as the FD-FDD mode.

In a half duplex (HD) transceiver, transmissions in each link direction may be separated by time domain resources. In some cases, the same carrier frequency is used for transmissions in each link direction, for example, carrier A is used for both the uplink and downlink transmissions, whereby such kind of half duplex may be referred to as the TDD mode. In some other cases, different carrier frequencies may be used for transmissions in each link direction, for example, carrier A may be used for the uplink transmissions while carrier B may be used for the downlink transmissions, whereby such kind of half duplex may be referred to as the HD-FDD mode.

Embodiments of the present disclosure provide improvements on the duplex modes, for example, as illustrated in FIG. 2. For example, advanced full duplex modes which enable simultaneous transmission and reception by the same device on the same carrier are provided. The advanced full duplex modes are advantageous. For example, the advanced full duplex modes may improve link throughput. In addition, transmission latency in the advanced full duplex modes may also be reduced due to simultaneous bidirectional transmission.

However, simultaneous DL transmission and UL transmission in the same carrier may incur self-interference. For example, on the BS side, the DL transmission may contaminate UL reception, while on the UE side, the UL transmission may contaminate DL reception.

It is more feasible to realize a full duplex on the BS side than on the UE side due to the following reasons. First, more space is available on the BS side such that transmitter (Tx) and receiver (Rx) antenna branches can be separated for self-interference cancellation. In addition, a more complex and advanced transceiver can be used on the BS side, which may be fundamental for self-interference cancellation.

Given the above, one scenario for implementing a full duplex mode is to deploy a full duplex mode on the BS side only, while still deploying a half duplex mode on the UE side. In such scenario, in a time unit (e.g., in terms of slot, symbol, sub-slot, etc.) with a full duplex mode, the BS may perform UL receptions from some UEs while performing DL transmissions to some other UEs. Non-overlapped frequency resources in the time unit may be allocated for UL receptions (from some UEs) and DL transmissions (to some other UEs) to mitigate self-interference. Such kind of full duplex mode may be referred to as a subband full duplex (SBFD).

The SBFD may be used in a TDD system to improve UL performance in the TDD system. For example, with the SBFD on the BS side, a UL subband(s) may be configured in some DL slots such that the UL transmission can be extended to be within such UL subband(s) in the DL slots while the DL transmission may be scheduled in the resources out of the UL subband(s). Here a subband corresponds to a set of frequency domain resources, e.g., a set of resource elements (REs) or resource blocks (RBs), and may be applicable to a time duration that is configured by a BS. Although the terminology “subband” is used for describing the embodiments of the present disclosure, other terminologies that correspond to a similar resource allocation to the subband, such as bandwidth part, are also applicable to the embodiments of the present disclosure.

FIG. 3 illustrates exemplary radio resources in a time division duplex (TDD) system according to some embodiments of the present disclosure.

In some examples, in a TDD system, DL transmissions and UL transmissions may be separated by time domain resources (e.g., slots). For example, the DL transmissions may be performed in DL slots #n-#n+2 as shown in FIG. 3 while the UL transmissions may be performed in the UL slots #n+3-#n+4 as shown in FIG. 3.

The SBFD on the BS side may be introduced to the TDD system. For example, for the UEs supporting the SBFD on the BS side, in addition to the UL transmission which may be scheduled in the active UL bandwidth parts (BWPs) in the UL slots, the UL transmission may also be scheduled in a subband in the DL slots in the TDD system. As shown in FIG. 3, UL transmissions may occur in a subband in DL slots #n+1 and #n+2. In other words, slot #n+1 and #n+2 are configured with a UL subband(s).

In some embodiment of the present disclosure, a CG may be used for UL transmissions. The benefits of the CG may include but are not limited to reducing control signaling overhead reduction and reducing latency since no scheduling request-grant cycle is needed before data transmission.

Several types of CGs, including for example, type 1 CG and type 2 CG, may be used for UL transmissions.

In type 1 CG, all the transmission parameters of the CG for UL transmission are configured by a CG configuration in RRC signaling, and the CG may be activated by the RRC signaling. For example, in response to receiving RRC signaling, the UE may start to use the CG for UL transmission if there is data in the buffer. From the CG configuration, the UE may determine the time instants (e.g., time slots, symbols, etc.) including CG resources, the channel related transmission parameters such as modulation and coding scheme, transmission power, etc., and reference signal related parameters, and so on. In addition, the type 1 CG may be deactivated by RRC signaling.

In type 2 CG, a part of the transmission parameters (e.g., periodicity of time instants including CG resources) of the CG for UL transmission are configured by a CG configuration in RRC signaling, and the remaining part of the transmission parameters (e.g., time and frequency resource allocation) of the CG for UL transmission are indicated by a DCI activating the CG. That is, in type 2 CG, the RRC signaling configuring the CG does not activate the CG. Instead, in response to receiving the activation DCI, the UE may start to use the CG for UL transmission if there is data in the buffer. In addition, the type 2 CG may be deactivated by a DCI (also referred to as deactivation DCI).

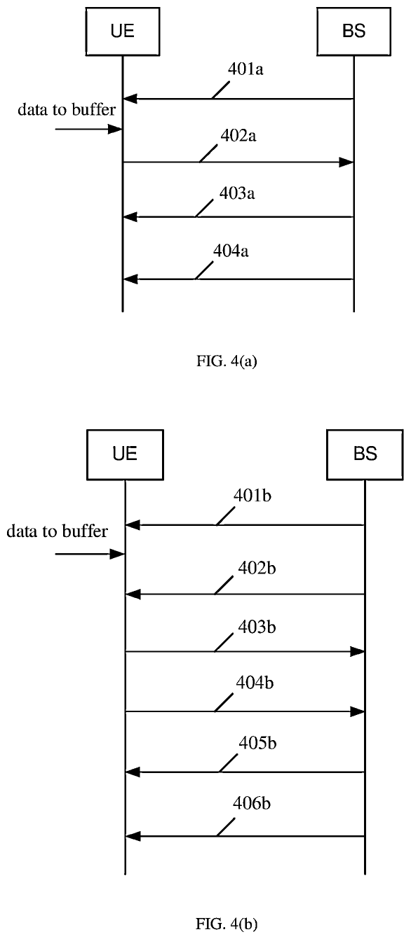

FIG. 4(a) illustrates an exemplary method for activating and deactivating type 1 CG according to some embodiments of the present disclosure.

Referring to FIG. 4(a), in step 401a, a BS may transmit RRC signaling to a UE. The RRC signaling may include all the transmitting parameters of a CG, e.g., periodicity, time offset, frequency resources, modulation and coding scheme (MSC), etc., for UL transmission.

In response to receiving the RRC signaling, in step 402a, the UE may start to use the CG for UL transmission if there is data in the buffer, for example, the UE may start to use the CG to transmit the buffered data in the time instant determined by the periodicity and time offset.

In response to receiving the UL transmission, in step 403a, the BS may transmit feedback for the UL transmission. If the BS intends to deactivate the CG, in step 404a, the BS may transmit another RRC signaling to deactivate the CG.

FIG. 4(b) illustrates an exemplary method for activating and deactivating type 2 CG according to some embodiments of the present disclosure.

Referring to FIG. 4(b), in step 401b, a BS may transmit RRC signaling to a UE. The RRC signaling may include a part of transmission parameters (e.g., periodicity) of a CG for UL transmission.

In step 402b, the BS may transmit a DCI (e.g., denoted as an activation DCI) activating the CG for UL transmission. The DCI may include the remaining of transmission parameters of the CG.

In response to receiving the activation DCI, the UE may acknowledge the activation by transmitting a medium access control (MAC) control element (CE) to the BS in step 403b.

In step 404b, the UE may start to use the CG for UL transmission if there is data in the buffer. For example, the UE may start to use the CG to transmit the buffered data in the time instant determined by the periodicity and time offset.

In response to receiving the UL transmission, in step 405b, the BS may transmit feedback for the UL transmission. If the BS intends to deactivate the CG, in step 406b, the BS may transmit another DCI (e.g., denoted as a deactivation DCI) to deactivate the CG grant.

In some embodiments of the present disclosure, CG enhancements may be used for UL transmission. For example, the CG enhancements may include using multiple CG configurations to support different traffic needs, where different traffic may have different requirements in terms of latency and reliability. In some embodiments, multiple CG configurations may only differ in the starting time instants, which can reduce latency. In some embodiments, each CG configuration of the multiple CG configurations may be allocated with a unique index, and thus each CG configuration may be indicated to be activated or deactivated separately.

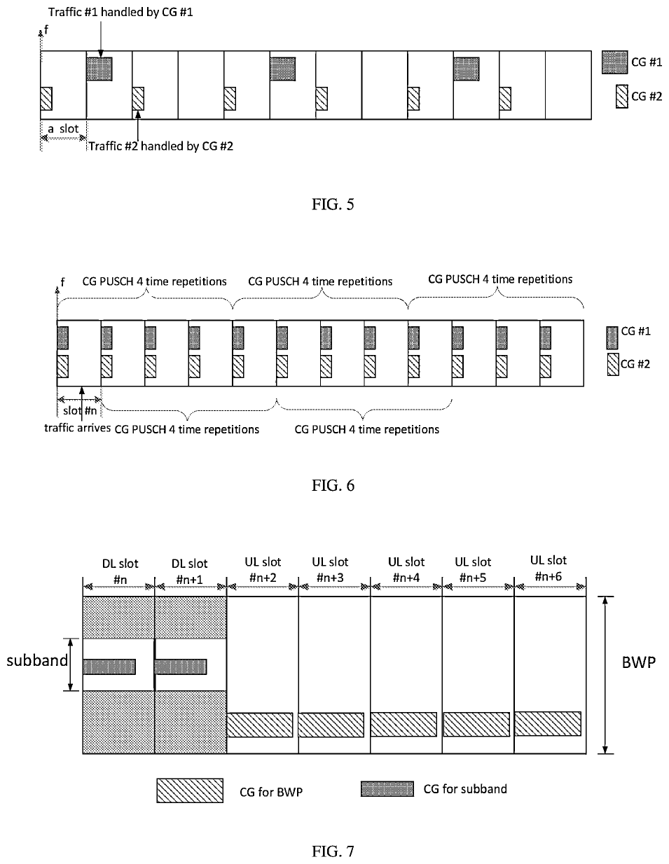

FIG. 5 illustrates exemplary CG configurations for different traffic needs according to some embodiments of the present disclosure.

FIG. 5 illustrates two CG configurations, wherein each CG configuration configures a CG. For example, the two CGs configured by the two CG configurations may be denoted as CG #1 and CG #2. CG #1 is configured with less frequent but larger resource allocation, which may be applied to traffic (e.g., traffic #1) with larger amounts of data and high latency tolerance. CG #2 is configured with frequent transmission opportunities, which may be applied to traffic (e.g., traffic #2) with low latency tolerance.

FIG. 6 illustrates exemplary CG configurations for latency reduction according to some embodiments of the present disclosure.

FIG. 6 illustrates two CG configurations, wherein each CG configuration configures a CG. For example, the two CG configured by the two CG configurations may be denoted as CG #1 and CG #2. CG #1 and CG #2 are configured with the same set of parameters except for different frequency positions and different starting instants for CG PUSCH repetition. For example, time units (e.g., a time unit in terms of slot, symbol, sub-slot, etc.) of CG #1 and CG #2 are the same and the repetition number of CG #1 and CG #2 are the same (e.g., “4” in FIG. 6).

When the traffic arrives, it may use the nearest CG resource to start the transmission. In the example of FIG. 6, the traffic may arrive at slot #n, the UE may use CG #2 to perform the PUSCH repetition for the traffic because a time instant of CG #2 is the nearest instant for performing the PUSCH repetition. Based on the CG configurations in FIG. 6, transmission latency for traffic is reduced.

The above embodiments in FIGS. 5 and 6 may illustrate a CG configuration for a BWP. To improve UL performance using SBFD, in some embodiments of the present disclosure, a CG may also be configured in a UL subband of a DL slot. The CG configuration for a BWP may be not suitable for a UL subband. The reasons are as follows.

First, different channel statuses in a UL subband and in a UL BWP require different channel related configurations, such as MCS, power control, transmit waveform, etc. For example, the channel quality in the UL subband may be worse than that in the UL BWP due to a larger interference level (e.g., additional self-interference as mentioned above).

Second, the UL subband and the UL BWP usually have different frequency domain positions and bandwidths (BWs), and thus the CGs for a UL subband and for a UL BWP may require different frequency domain resource allocations in the UL subband and in the UL BWP.

Third, CGs for a UL subband and for a UL BWP may require different time domain positions in a slot of the UL subband and in a slot of the UL BWP, and thus time domain resource allocation for CGs in the UL subband and in the UL BWP may be different.

Given the above, the CG for a UL subband may need to have different configurations (fully or partially) than the CG for a UL BWP. Then, how to configure a CG for the UL subband needs to be addressed.

Embodiments of the present disclosure provide solutions for a CG configuration(s) for a UL subband in a full duplex system. For example, embodiments of the present disclosure propose solutions regarding setting separate CG configurations for the UL subband and the UL BWP, how to transmit the separate CG configurations for the UL subband and the UL BWP, and how to use the CG configurations for the UL subband and the UL BWP. Solutions in the embodiments of the present disclosure can facilitate UL transmissions in DL slots, thereby achieving better UL coverage, lower UL transmission latency and improved UL capability. More details on embodiments of the present disclosure will be described in the following text in combination with the appended drawings.

FIG. 7 illustrates an exemplary CG configuration for a UL subband and a CG configuration for a UL BWP according to some embodiments of the present disclosure.

In some examples, in a TDD system, DL transmissions and UL transmissions may be separated by time domain resources (e.g., slots). For example, the DL transmissions may be performed in DL slots #n and #n+1 as shown in FIG. 7 while the UL transmissions may be performed in the UL slots #n+2-#n+6 as shown in FIG. 7. The SBFD on the BS side may be introduced to the TDD system. For example, slot #n and #n+1 may be configured with a UL subband.

The BS may transmit separate CG configurations for the CG in the UL subband (denoted as subband in FIG. 7) and the CG for the UL BWP (denoted as BWP in FIG. 7) to a UE, which may result in different CGs in the UL subband and in the BWP as shown in FIG. 7.

To achieve separate CG configurations for a CG in a UL subband and a CG for a UL BWP, one solution is that the CG configuration for the UL subband and the CG configuration for the BWP may be transmitted in the same RRC signaling. For example, RRC signaling configuring the CG for a BWP may include a CG configuration for a subband.

One issue with this solution is inflexible CG activation or CG deactivation, especially for type 2 CG. For example, according to the method for activating or deactivating a type 2 CG, the CG for a UL subband and the CG for a BWP will be activated or deactivated simultaneously since they are configured using the same RRC signaling. However, it is desirable to allow separate activation or deactivation of a CG in a subband and a CG in a BWP to achieve flexible resource allocation. Another issue is cumbersome RRC signaling for a CG configuration(s) with so many different configurations for the CG for a subband and the CG for a BWP, as analyzed above.

Another solution is to use two different RRC signaling for the CG configuration for a subband and the CG configuration for a BWP, respectively. For example, a separate RRC signaling is used for a CG configuration(s) for a subband, which is different from the RRC signaling for the CG configuration for a BWP. With a different CG index of each CG configuration, this solution can achieve flexible activation or deactivation of the CG configuration for a subband and the CG configuration for a BWP. However, this solution cannot achieve CG PUSCH repetition among the resources in the CG for a UL subband and the CG for a BWP, since repetition between multiple CGs is not supported. This may lead to higher PUSCH transmission latency.

Embodiments of the present disclosure further provide enhanced solutions for a CG configuration for a UL subband, which can solve the above issues.

FIG. 8 is a flow chart illustrating exemplary method 800 for a CG configuration in a full duplex system according to some embodiments of the present disclosure. The method in FIG. 8 may be implemented by a UE (e.g., UE 101 as shown in FIG. 1).

In the exemplary method shown in FIG. 8, in step 801, a UE may receive a CG configuration (e.g., CG configuration #1) for a UL BWP from a BS. In step 803, the UE may receive a CG configuration (e.g., CG configuration #2) for a UL subband from the BS. Step 803 may occur before, after, or simultaneously with step 801.

According to some embodiments of the present disclosure, CG configuration #1 and CG configuration #2 may be received in the same signaling (e.g., signaling #1). For example, signaling #1 may be an RRC signaling. In some embodiments, signaling #1 may be RRC signaling configuring a CG for the UL BWP. That is, the RRC signaling configuring a CG for the UL BWP may include a CG configuration for the UL subband.

In some embodiments, a type of the CG configured by CG configuration #1 and a type of the CG configured by CG configuration #2 may be different.

In an embodiment, CG configuration #1 configures a type 1 CG for the UL BWP, and CG configuration #2 configures a type 2 CG for the UL subband. For example, signaling #1 includes full parameters for a CG for the UL BWP but only includes a part of the parameters for a CG for the UL subband.

In such embodiment, if the UE receives DCI (e.g., DCI #1) for the CG activation (e.g., activating a CG configured by signaling #1), DCI #1 only activates the type 2 CG for the UL subband, but not the type 1 CG for the UL BWP. The type 1 CG for the UL BWP is activated in response to the UE receiving signaling #1.

Similarly, if the UE receives DCI (e.g., DCI #2) for CG deactivation (e.g., deactivating a CG configured by signaling #1), DCI #2 only deactivates the type 2 CG for the UL subband, but not the type 1 CG for the UL BWP. The type 1 CG for the UL BWP may be deactivated by another signaling (e.g., another RRC signaling).

In another embodiment, CG configuration #1 configures a type 2 CG for the UL BWP, and CG configuration #2 configures a type 1 CG for the UL subband. For example, signaling #1 includes full parameters for a CG for the UL subband but only includes a part of the parameters for a CG for the UL BWP.

In such embodiment, if the UE receives DCI (e.g., DCI #1′) for CG activation (e.g., activating a CG configured by signaling #1), DCI #1′ only activates the type 2 CG for the UL BWP, but not the type 1 CG for the UL subband. The type 1 CG for the UL subband is activated in response to the UE receiving signaling #1.

Similarly, if the UE receives DCI (e.g., DCI #2′) for CG deactivation (e.g., deactivating a CG configured by signaling #1), DCI #2′ only deactivates the type 2 CG for the UL BWP, but not the type 1 CG for the UL subband. The type 1 CG for the UL subband may be deactivated by another signaling (e.g., another RRC signaling).

In some embodiments, a type of the CG configured by CG configuration #1 and a type of the CG configured by CG configuration #2 may be the same.

In an embodiment, CG configuration #1 configures a type 1 CG for the UL BWP, and CG configuration #2 configures a type 1 CG for the UL subband. For example, signaling #1 includes full parameters for the CG for the UL BWP and full parameters for the CG for the UL subband. In such embodiment, both the type 1 CG for the UL BWP and the type 1 CG for the UL subband are activated by signaling #1 (e.g., in response to the UE receiving s signaling #1), and are deactivated by another signaling (e.g., another RRC signaling).

In another embodiment, CG configuration #1 configures a type 2 CG for the UL BWP, and CG configuration #2 configures a type 2 CG for the UL subband. That is, signaling #1 includes a part of the parameters for the CG for the UL subband and includes a part of the parameters for the CG for the UL BWP.

In some cases, the UE may receive DCI (e.g., DCI #1A) for CG activation (e.g., activating a CG configured by signaling #1).

In an example, DCI #1A may include an indication (e.g., a bit field) indicating to activate the type 2 CG for the UL BWP, the type 2 CG for the UL subband, or both the type 2 CG for the UL BWP and the type 2 CG for the UL BWP. Accordingly, based on the indication, the UE may determine to activate which type 2 CG(s).

In another example, a CRC of DCI #1A may be scrambled by a RNTI, and whether the type 2 CG for the UL BWP or the type 2 CG for the UL subband is activated by DCI #1A is determined based on the RNTI. In such embodiment, an RNTI for scrambling the CRC of a DCI activating type 2 CG for the UL BWP is different from an RNTI for scrambling the CRC of a DCI activating type 2 CG for the UL subband. Accordingly, based on the RNTI for DCI #1A, the UE may determine to activate which type 2 CG.

In another example, in response to receiving DCI #1A for CG activation, the type 2 CG for the UL BWP and the type 2 CG for the UL subband are always activated simultaneously.

In some other cases, the UE may receive DCI (e.g., DCI #2A) for CG deactivation (e.g., deactivating a CG configured by signaling #1).

In an example, DCI #2A may include an indication (e.g., a bit field) indicating to deactivate the type 2 CG for the UL BWP, the type 2 CG for the UL subband, or both the type 2 CG for the UL BWP and the type 2 CG for the UL BWP. Accordingly, based on the indication, the UE may determine to deactivate which type 2 CG(s).

In another example, a CRC of DCI #2A may be scrambled by a RNTI, and whether the type 2 CG for the UL BWP or the type 2 CG for the UL subband is deactivated by DCI #2A is determined based on the RNTI. In such embodiment, an RNTI for scrambling the CRC of a DCI deactivating type 2 CG for the UL BWP is different from an RNTI for scrambling the CRC of a DCI deactivating type 2 CG for the UL subband. Accordingly, based on the RNTI for DCI #2A, the UE may determine to deactivate which type 2 CG.

In another example, in response to receiving DCI #2A for CG deactivation, the type 2 CG for the UL BWP and the type 2 CG for the UL subband are always deactivated simultaneously.

In some embodiments, CG configuration #2 may share some parameters with CG configuration #1. For example, the shared parameters may be included in the CG configuration #1 but not included in the configuration #2. The shared parameters may be applicable for CG configuration #2.

In an embodiment, the shared parameters may include a first set of parameters for determining time units including CG resources. The first set of parameters may include at least one of: periodicity, time offset, etc. In such embodiment, the UE may determine a time unit including CG resources based on the first set of parameters. In the case that the time unit is a DL time unit with the UL subband, CG resources for the UL subband determined based on CG configuration #2 are available for a PUSCH transmission. In the case that the time unit is a UL time unit, CG resources for the UL BWP determined based on CG configuration #1 are available for a PUSCH transmission.

A time unit in the context of the present disclosure may be in terms of slot, symbol, sub-slot, etc. For example, a time unit may include one or more slots, one or more symbols, or one or more sub-slots.

Alternatively or additionally, the shared parameters may include a second set of parameters for PUSCH repetition. The second set of parameters may include at least one of: starting point (e.g., starting instant) of repetition, repetition number, etc. In such cases, the CG resources for the UL subband are available for PUSCH repetition. Accordingly, when a PUSCH repetition is configured for the UE, the UE may perform a PUSCH repetition between CG resources for the UL subband determined based on CG configuration #2 and CG resources for the UL BWP determined based on CG configuration #1.

In some embodiments, the UE may receive a configuration from the BS.

In some examples, the configuration may indicate the UE to perform the PUSCH repetition only in the time units determined from the CG for the UL subband, only in the time units determined from the CG for the UL BWP, or in the time units determined from both the CG for the UL subband and the CG for the UL BWP. In such examples, the UE may perform the PUSCH repetition according to the configuration.

In some examples, the configuration may indicate whether the UE to perform the PUSCH repetition in the time units determined from both the CG for the UL subband and the CG for the UL BWP or not. In such example, if the configuration indicates the UE to perform the PUSCH repetition in the time units determined from both the CG for the UL subband and the CG for the UL BWP, the UE may perform the PUSCH repetition in the time units determined from both the CG for the UL subband and the CG for the UL BWP. If the configuration indicates the UE not to perform the PUSCH repetition in the time units determined from both the CG for the UL subband and the CG for the UL BWP, the UE may perform the PUSCH repetition only in the time units determined from the CG for the UL subband or only in the time units determined from the CG for the UL BWP.

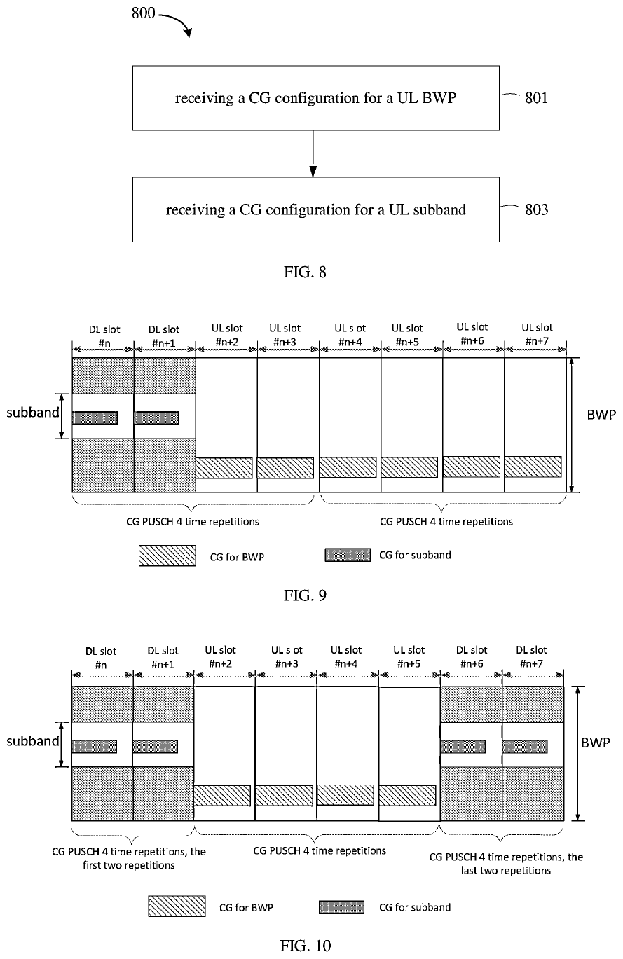

FIG. 9 illustrates an exemplary PUSCH repetition among CG resources of a CG for a subband and CG resources for a BWP according to some embodiments of the present disclosure.

Referring to FIG. 9, it is assumed that the UE receives two CG configurations (e.g., denoted as CG configuration #1A and CG configuration #2A) in RRC signaling. The above descriptions regarding CG configuration #1 and CG configuration #2 may apply to CG configuration #1A and CG configuration #2A, respectively.

In some examples, CG configuration #1A configures a CG for a UL BWP, and includes a set of parameters for PUSCH repetition, for example, the repetition number is 4. CG configuration #2A configures a CG for the UL subband, which shares the set of parameters for PUSCH repetition in CG configuration #1A.

Based on the set of parameters for PUSCH repetition in CG configuration #1A, the UE may determine that the PUSCH repetition is performed in every 4 time units. For example, the PUSCH repetition may be performed in slot #n to slot #n+3 or in slot #n+4 to slot #n+7 as shown in FIG. 9. Slot #n to slot #n+3 for PUSCH repetition may include two DL slots with a UL subband where the CG for the subband is configured and two UL slots with the BWP where the CG for the BWP is configured. Slot #n+4 to slot #n+7 may include four slots with a BWP where the CG for the BWP is configured. The UE may perform a PUSCH repetition between CG resources for the UL subband in slot #n and slot #n+1 determined based on CG configuration #2A and CG resources for the UL BWP in slot #n+2 and #n+3 determined based on CG configuration #1A.

According to some embodiments of the present disclosure, CG configuration #1 and CG configuration #2 may be received in different signaling. For example, CG configuration #1 is received in signaling (e.g., signaling #2) and CG configuration #2 is received in another signaling (e.g., signaling #3) different from the signaling including CG configuration #1. In some embodiments, CG configuration #1 may be associated with CG configuration #2. The following embodiments provide several solutions to determine an association between CG configuration #1 and CG configuration #2.

In some embodiments of the present disclosure, an association of the CG configuration #1 and CG configuration #2 may be indicated in signaling #3. For example, signaling #3 may include an indication indicating that CG configuration #2 is associated with a specific CG configuration for a UL BWP (e.g., CG configuration #1). For example, the indication may indicate an index of CG configuration #1.

In some other embodiments of the present disclosure, the association of CG configuration #1 and CG configuration #2 may be based on an index of CG configuration #1 and an index of CG configuration #2. For example, the UE may receive a list of CG configurations for the UL BWP (denoted as first list) and a list of CG configurations for the UL subband (denoted as second list). The configuration in the first list may be associated with a corresponding configuration in the second list.

For instance, when an index of a CG configuration in the first list and an index of a CG configuration in the second list have a configured or preconfigured difference between each other, the CG configuration in the first list and the CG configuration in the second list are associated with each other. For example, the configured or preconfigured difference may be “0.” That is, a CG configuration in the first list is associated with a CG configuration in the second list when they have the same index. In such example, when CG configuration #1 and CG configuration #2 have the same index, the UE may determine that they are associated with each other.

In some embodiments, the UE may determine a first set of time units with CG resources for the UL BWP based on CG configuration #1 and a second set of time units with CG resources for the UL subband based on CG configuration #2.

In some cases, the first set of time units and the second set of time units may include the same one or more time units (e.g., time unit #1). Then, for time unit #1, when CG resources for the UL BWP are not within the UL subband in time unit #1, the UE may determine that CG resources for the UL subband are available for a PUSCH transmission in time unit #1; and when CG resources for the UL BWP are within the UL subband in time unit #1, whether CG resources for the UL subband or CG resources for the UL BWP are available for a PUSCH transmission in time unit #1 is configured or preconfigured.

In such cases, when a PUSCH repetition is configured for the UE, the UE may perform the PUSCH repetition in a time unit(s) of the second set of time units with available CG resources for the UL subband and a time unit(s) of the second set of time units with available CG resources for the UL BWP.

For example, it is assumed that the first set of time units includes slot #m to slot #m+7 and the second set of time units includes slot #m and #m+1. Therefore, both the first set of time units and the second set of time units include slot #m and slot #m+1. It is further assumed that CG resources for the UL BWP are not within the UL subband in slot #m and slot #m+1, and the UE may determine that CG resources for the UL subband in slot #m and slot #m+1 are available for a PUSCH transmission. When a PUSCH repetition is configured for the UE, the UE may perform the PUSCH repetition in slot #m and slot #m+1 with available CG resources for the UL subband and in slot #m+2 to slot #m+7 with available CG resources for the UL BWP.

In some embodiments of the present disclosure, CG configuration #1 includes at least one parameter which is not included in CG configuration #2 but is applicable for CG configuration #2. For example, the at least one parameter including one or more of the following: a first set of parameters (e.g., periodicity, offset, etc.) for determining a time unit(s) including CG resources; or a second set of parameters (e.g., a number of repetitions, etc.) for PUSCH repetition.

In such embodiments, the UE may determine a time unit based on the first set of parameters, and in the case that the time unit is configured with the UL subband, CG resources for the UL subband determined based on CG configuration #2 are available for a PUSCH transmission in the time unit.

Still referring to FIG. 9, it is assumed that the UE receives a CG configuration (e.g., CG configuration #1B) in one RRC signaling and receives another CG configuration (e.g., CG configuration #2B) in another different RRC signaling. CG configuration #1B and CG configuration #2B are associated with each other. The above descriptions regarding CG configuration #1 and CG configuration #2 may apply to CG configuration #1B and CG configuration #2B, respectively.

In some examples, CG configuration #1B configures a CG for a UL BWP, which includes a first set of parameters (e.g., periodicity, offset, etc.) for determining a time unit(s) including CG resources and a second set of parameters for PUSCH repetition, for example, the repetition number is 4. CG configuration #2B configures the CG for the UL subband. Some or all parameters of the first set of parameters and the second set of parameters may not be included in CG configuration #2B but are applicable for CG configuration #2B.

Based on CG configuration #1B, the UE may determine slot #n to slot #n+7 including CG resources as shown in FIG. 9. Since slot #n and slot #n+1 are configured with the UL subband, the UE may determine CG resources for the UL subband determined based on the second configuration are available for a PUSCH transmission in slot #n and slot #n+1.

When a PUSCH repetition is configured, the UE may perform the PUSCH repetition in slot #n to slot #n+3 or in slot #n+4 to slot #n+7 as shown in FIG. 9. Slot #n to slot #n+3 for PUSCH repetition may include two DL slots with a UL subband where the CG for the subband is configured and two UL slots with the BWP where the CG for the BWP is configured. Slot #n+4 to slot #n+7 may include four UL slots with a BWP where the CG for the BWP is configured.

According to some embodiments of the present disclosure, CG configuration #1 and CG configuration #2 may be received in different signaling. For example, CG configuration #1 is received in a signaling (e.g., signaling #2′) and CG configuration #2 is received in another signaling (e.g., signaling #3′) different from the signaling including CG configuration #1. In some embodiments, CG configuration #1 is not associated with CG configuration #2.

In some embodiments of the present disclosure, signaling #3′ may include an indication indicating that CG configuration #2 is specific for a CG for the UL subband. In this way, CG configuration #2 is indicated to be not associated with any CG configuration for a UL BWP.

In some cases, a collision may happen when the time units determined based on CG configuration #2 include UL time units, or the time units determined based on CG configuration #1 include DL time units configured with a UL subband. In such cases, a CG for the UL subband is only available for DL time units with the UL subband. In the case that a time unit determined based on CG configuration #2 is a UL time unit, CG resources for the UL subband determined based on CG configuration #2 are not available in the UL time unit.

A CG for the UL BWP is only available for normal UL time units. In the case that a time unit determined based on CG configuration #1 is a DL time unit configured with the UL subband, CG resources for the UL BWP determined based on CG configuration #1 are not available in the DL time unit.

In some embodiments, repetition related parameters may be separately configured in CG configuration #1 and CG configuration #2. When a PUSCH repetition is configured for a UE, the UE may perform a PUSCH repetition in a set of UL time units with CG resources for the UL BWP determined based on CG configuration #1 or in a set of DL time units with CG resources for the UL subband determined based on CG configuration #2. In other words, the PUSCH repetition may happen only in the DL time units with the UL subband, or only in the UL time units with the UL BWP (e.g., normal UL slots).

FIG. 10 illustrates an exemplary method for performing a PUSCH repetition according to some embodiments of the present disclosure.

Referring to FIG. 10, it is assumed that the UE receives CG configuration #1C in one RRC signaling and receives CG configuration #2C in another different RRC signaling. CG configuration #1C and CG configuration #2C are not associated with each other. CG configuration #1C configures a CG for a UL BWP. CG configuration #2C configures a CG for the UL subband.

Based on CG configuration #1C, the UE may determine slot #n+2 to slot #n+5 are UL slots including available CG resources for the UL BWP as shown in FIG. 10. Based on CG configuration #2C, the UE may determine slot #n, slot #n+1, slot #6, and slot #n+7 are DL slots including available CG resources for the UL subband as shown in FIG. 10. When a PUSCH repetition is configured for a UE, the PUSCH repetition may happen only in the DL time units with the UL subband, or only in the UL time units with the UL BWP.

In the example of FIG. 10, it is assumed that the repetition number is 4. The UE may perform the first two PUSCH repetitions of the 4 PUSCH repetitions in slot #n and slot #n+1 including available CG resources for the UL subband, and then perform the last two PUSCH repetitions of the 4 PUSCH repetitions in slot #n+6 and slot #n+7 including available CG resources for the UL subband. Otherwise, the UE may perform the 4 PUSCH repetitions in slot #n+2 to slot #n+5 including available CG resources for the UL BWP.

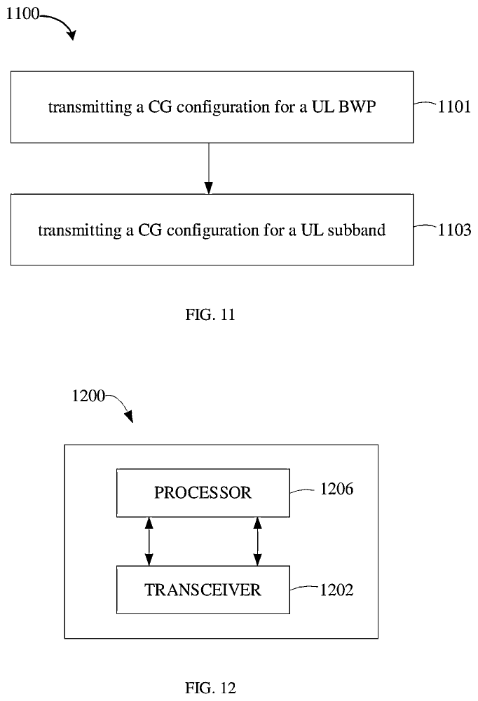

FIG. 11 is a flow chart illustrating an exemplary method 1100 for CG configuration in a full duplex system according to some embodiments of the present disclosure. The method in FIG. 11 may be implemented by a BS (e.g., BS 102 as shown in FIG. 1).

In the exemplary method shown in FIG. 11, in step 1101, the BS may transmit, to a UE (e.g., UE 101 as shown in FIG. 1), a CG configuration (e.g., CG configuration #1) for a UL BWP. In step 1103, the BS may receive a CG configuration (e.g., CG configuration #2) for a UL subband to the UE. Step 1103 may occur before, after, or simultaneously with step 1101.

According to some embodiments of the present disclosure, CG configuration #1 and CG configuration #2 may be transmitted in the same signaling (e.g., signaling #1). For example, signaling #1 may be an RRC signaling. In some embodiments, signaling #1 may be RRC signaling configuring CG for the UL BWP. That is, the RRC signaling configuring a CG for the UL BWP may include a CG configuration for the UL subband.

In some embodiments, a type of the CG configured by CG configuration #1 and a type of the CG configured by CG configuration #2 may be different.

In an embodiment, CG configuration #1 configures a type 1 CG for the UL BWP, and CG configuration #2 configures a type 2 CG for the UL subband. For example, signaling #1 includes full parameters for a CG for the UL BWP but only includes a part of the parameters for a CG for the UL subband.

In such embodiment, if the BS transmits DCI (e.g., DCI #1) for CG activation (e.g., activating a CG configured by signaling #1), DCI #1 only activates the type 2 CG for the UL subband, but not the type 1 CG for the UL BWP. The type 1 CG for the UL BWP is activated in response to the UE receiving signaling #1.

Similarly, if the BS transmits DCI (e.g., DCI #2) for CG deactivation (e.g., deactivating a CG configured by signaling #1), DCI #2 only deactivates the type 2 CG for the UL subband, but not the type 1 CG for the UL BWP. The BS may transmit another signaling (e.g., another RRC signaling) to deactivate the type 1 CG for the UL BWP.

In another embodiment, CG configuration #1 configures a type 2 CG for the UL BWP, and CG configuration #2 configures a type 1 CG for the UL subband. For example, signaling #1 includes full parameters for a CG for the UL subband but only includes a part of the parameters for a CG for the UL BWP.

In such embodiment, if the BS transmits DCI (e.g., DCI #1′) for CG activation (e.g., activating a CG configured by signaling #1), DCI #1′ only activates the type 2 CG for the UL BWP, but not the type 1 CG for the UL subband. The type 1 CG for the UL subband is activated in response to the UE receiving signaling #1.

Similarly, if the BS transmits DCI (e.g., DCI #2′) for CG deactivation (e.g., deactivating a CG configured by signaling #1), DCI #2′ only deactivates the type 2 CG for the UL BWP, but not the type 1 CG for the UL subband. The BS may transmit another signaling (e.g., another RRC signaling) to deactivate the type 1 CG for the UL subband.

In some embodiments, a type of the CG configured by CG configuration #1 and a type of the CG configured by CG configuration #2 may be the same.

In an embodiment, CG configuration #1 configures a type 1 CG for the UL BWP, and CG configuration #2 configures a type 1 CG for the UL subband. For example, signaling #1 includes full parameters for the CG for the UL BWP and full parameters for the CG for the UL subband. In such embodiment, both the type 1 CG for the UL BWP and the type 1 CG for the UL subband are activated by signaling #1 (e.g., in response to the UE receiving signaling #1). The BS may transmit another signaling (e.g., another RRC signaling) to deactivate the type 1 CG for the UL BWP and the type 1 CG for the UL subband.

In another embodiment, CG configuration #1 configures a type 2 CG for the UL BWP, and CG configuration #2 configures a type 2 CG for the UL subband. That is, signaling #1 includes a part of the parameters for the CG for the UL subband and includes a part of the parameters for the CG for the UL BWP.

In some cases, the BS may transmit DCI (e.g., DCI #1A) for CG activation (e.g., activating a CG configured by signaling #1).

In an example, DCI #1A may include an indication (e.g., a bit field) indicating to activate the type 2 CG for the UL BWP, the type 2 CG for the UL subband, or both the type 2 CG for the UL BWP and the type 2 CG for the UL BWP.

In another example, a CRC of DCI #1A may be scrambled by a RNTI, and whether the type 2 CG for the UL BWP or the type 2 CG for the UL subband is activated by DCI #1A is determined based on the RNTI. In such embodiment, an RNTI for scrambling the CRC of a DCI activating type 2 CG for the UL BWP is different from an RNTI for scrambling the CRC of a DCI activating type 2 CG for the UL subband.

In another example, in response to transmitting DCI #1A for CG activation, the type 2 CG for the UL BWP and the type 2 CG for the UL subband are always activated simultaneously.

In some other cases, the BS may transmit DCI (e.g., DCI #2A) for CG deactivation (e.g., deactivating a CG configured by signaling #1).

In an example, DCI #2A may include an indication (e.g., a bit field) indicating to deactivate the type 2 CG for the UL BWP, the type 2 CG for the UL subband, or both the type 2 CG for the UL BWP and the type 2 CG for the UL BWP.

In another example, a CRC of DCI #2A may be scrambled by a RNTI, and whether the type 2 CG for the UL BWP or the type 2 CG for the UL subband is deactivated by DCI #2A is determined based on the RNTI. In such embodiment, an RNTI for scrambling the CRC of a DCI deactivating type 2 CG for the UL BWP is different from an RNTI for scrambling the CRC of a DCI deactivating type 2 CG for the UL subband.

In another example, in response to transmitting DCI #2A for CG deactivation, the type 2 CG for the UL BWP and the type 2 CG for the UL subband are always deactivated simultaneously.

In some embodiments, CG configuration #2 may share some parameters with CG configuration #1. For example, the shared parameters may be included in the CG configuration #1 but not included in the configuration #2. The shared parameters may be applicable for CG configuration #2.

In an embodiment, the shared parameters may include a first set of parameters for determining time units including CG resources. The first set of parameters may include at least one of: periodicity, time offset, etc. In such embodiment, the BS may determine a time unit including CG resources based on the first set of parameters. In the case that the time unit is a DL time unit with the UL subband, CG resources for the UL subband determined based on CG configuration #2 are available for a PUSCH transmission. In the case that the time unit is a UL time unit, CG resources for the UL BWP determined based on CG configuration #1 are available for a PUSCH transmission.

Alternatively or additionally, the shared parameters may include a second set of parameters for PUSCH repetition. The second set of parameters may include at least one of: starting point (e.g., starting instant) of repetition, repetition number, etc. In such cases, the CG resources for the UL subband are available for PUSCH repetition. Accordingly, when a PUSCH repetition is configured for the UE, the BS may receive a PUSCH repetition between CG resources for the UL subband determined based on CG configuration #2 and CG resources for the UL BWP determined based on configuration #1. An example for receiving a PUSCH repetition among CG resources of CG for subband and CG resources for BWP may refer to FIG. 9.

In some embodiments, the BS may transmit a configuration to the UE.

In some examples, the configuration may indicate the UE to perform the PUSCH repetition only in the time units determined from the CG for the UL subband, only in the time units determined from the CG for the UL BWP, or in the time units determined from both the CG for the UL subband and the CG for the UL BWP. In such examples, the BS may receive the PUSCH repetition according to the configuration.

In some examples, the configuration may indicate whether the UE to perform the PUSCH repetition in the time units determined from both the CG for the UL subband and the CG for the UL BWP or not. In such example, if the configuration indicates the UE to perform the PUSCH repetition in the time units determined from both the CG for the UL subband and the CG for the UL BWP, the BS may receive the PUSCH repetition in the time units determined from both the CG for the UL subband and the CG for the UL BWP. If the configuration indicates the UE not to perform the PUSCH repetition in the time units determined from both the CG for the UL subband and the CG for the UL BWP, the BS may receive the PUSCH repetition only in the time units determined from the CG for the UL subband or only in the time units determined from the CG for the UL BWP.

According to some embodiments of the present disclosure, CG configuration #1 and CG configuration #2 may be transmitted in different signaling. For example, CG configuration #1 is transmitted in signaling (e.g., signaling #2) and CG configuration #2 is transmitted in another signaling (e.g., signaling #3) different from the signaling including CG configuration #1. In some embodiments, CG configuration #1 may be associated with CG configuration #2. The following embodiments provide several solutions to determine an association between CG configuration #1 and CG configuration #2.

In some embodiments of the present disclosure, an association of the CG configuration #1 and CG configuration #2 may be indicated in signaling #3. For example, signaling #3 may include an indication indicating that CG configuration #2 is associated with a specific CG configuration for a UL BWP (e.g., CG configuration #1). For example, the indication may indicate an index of CG configuration #1.

In some other embodiments of the present disclosure, the association of CG configuration #1 and CG configuration #2 may be based on an index of CG configuration #1 and an index of CG configuration #2. For example, the BS may transmit a list of CG configurations for the UL BWP (denoted as first list) and a list of CG configurations for the UL subband (denoted as second list). The configuration in the first list may be associated with a corresponding configuration in the second list.

For instance, when an index of a CG configuration in the first list and an index of a CG configuration in the second list have a configured or preconfigured difference between each other, the CG configuration in the first list and the CG configuration in the second list are associated with each other. For example, the configured or preconfigured difference may be “0.” That is, a CG configuration in the first list is associated with a CG configuration in the second list when they have the same index.

In some embodiments, the BS may determine a first set of time units with CG resources for the UL BWP based on CG configuration #1 and a second set of time units with CG resources for the UL subband based on CG configuration #2.

In some cases, the first set of time units and the second set of time units may include the same one or more time units (e.g., time unit #1). Then, for time unit #1, when CG resources for the UL BWP are not within the UL subband in time unit #1, the BS may determine that CG resources for the UL subband are available for a PUSCH transmission in time unit #1. When CG resources for the UL BWP are within the UL subband in time unit #1, in some examples, the BS may transmit, to the UE, a configuration indicating which one of the CG resources for the UL subband and CG resources for the UL BWP are available for a PUSCH transmission in time unit #1; in some other examples, which one of the CG resources for the UL subband or CG resources for the UL BWP are available for a PUSCH transmission in time unit #1 is preconfigured.

In such cases, when a PUSCH repetition is configured for the UE, the BS may receive the PUSCH repetition in a time unit(s) of the second set of time units with available CG resources for the UL subband and a time unit(s) of the second set of time units with available CG resources for the UL BWP.

In some embodiments of the present disclosure, CG configuration #1 includes at least one parameter which is not included in CG configuration #2 but is applicable for CG configuration #2. For example, the at least one parameter including one or more of the following: a first set of parameters (e.g., periodicity, offset, etc.) for determining a time unit(s) including CG resources; or a second set of parameters (e.g., a number of repetitions, etc.) for PUSCH repetition.

In such embodiments, the BS may determine a time unit based on the first set of parameters, and in the case that the time unit is configured with the UL subband, CG resources for the UL subband determined based on CG configuration #2 are available for a PUSCH transmission in the time unit.

According to some embodiments of the present disclosure, CG configuration #1 and CG configuration #2 may be received in different signaling. For example, CG configuration #1 is received in a signaling (e.g., signaling #2′) and CG configuration #2 is received in another signaling (e.g., signaling #3′) different from the signaling including CG configuration #1. In some embodiments, CG configuration #1 is not associated with CG configuration #2.

In some embodiments of the present disclosure, signaling #3′ may include an indication indicating that CG configuration #2 is specific for a CG for the UL subband. In this way, CG configuration #2 is indicated to be not associated with any CG configuration for a UL BWP.

In some cases, collision may happen when the time units determined based on CG configuration #2 include UL time units, or the time units determined based on CG configuration #1 include DL time units configured with a UL subband. In such cases, a CG for the UL subband is only available for DL time units with the UL subband. In the case that a time unit determined based on CG configuration #2 is a UL time unit, CG resources for the UL subband determined based on CG configuration #2 are not available in the UL time unit.

A CG for the UL BWP is only available for normal UL time units. In the case that a time unit determined based on CG configuration #1 is a DL time unit configured with the UL subband, CG resources for the UL BWP determined based on CG configuration #1 are not available in the DL time unit.

In some embodiments, the BS may transmit repetition related parameters in CG configuration #1 and CG configuration #2 separately. When a PUSCH repetition is configured for a UE, the BS may receive a PUSCH repetition in a set of UL time units with CG resources for the UL BWP determined based on CG configuration #1 or in a set of DL time units with CG resources for the UL subband determined based on CG configuration #2. In other words, the PUSCH repetition may happen only in the DL time units with the UL subband, or only in the UL time units with the UL BWP (e.g., normal UL slots). An example of receiving a PUSCH repetition with non-associated CG configurations may refer to FIG. 10.

FIG. 12 illustrates a simplified block diagram of an exemplary apparatus for CG configuration in a full duplex system according to some embodiments of the present disclosure. As shown in FIG. 12, the apparatus 1200 may include at least one processor 1206 and at least one transceiver 1202 coupled to the processor 1206. The apparatus 1200 may be a UE or a BS.

Although in this figure, elements such as the at least one transceiver 1202 and processor 1206 are described in the singular, the plural is contemplated unless a limitation to the singular is explicitly stated. In some embodiments of the present disclosure, the transceiver 1202 may be divided into two devices, such as a receiving circuitry and a transmitting circuitry. In some embodiments of the present disclosure, the apparatus 1200 may further include an input device, a memory, and/or other components.

In some embodiments of the present disclosure, the apparatus 1200 may be a UE. The transceiver 1202 and the processor 1206 may interact with each other so as to perform the operations with respect to the UE described in FIGS. 1-11. In some embodiments of the present disclosure, the apparatus 1200 may be a BS. The transceiver 1202 and the processor 1206 may interact with each other so as to perform the operations with respect to the BS described in FIGS. 1-11.

In some embodiments of the present disclosure, the apparatus 1200 may further include at least one non-transitory computer-readable medium.

For example, in some embodiments of the present disclosure, the non-transitory computer-readable medium may have stored thereon computer-executable instructions to cause the processor 1206 to implement the method with respect to the UE as described above. For example, the computer-executable instructions, when executed, cause the processor 1206 interacting with transceiver 1202 to perform the operations with respect to the UE described in FIGS. 1-11.

In some embodiments of the present disclosure, the non-transitory computer-readable medium may have stored thereon computer-executable instructions to cause the processor 1206 to implement the method with respect to the BS as described above. For example, the computer-executable instructions, when executed, cause the processor 1206 interacting with transceiver 1202 to perform the operations with respect to the BS described in FIGS. 1-11.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

What is claimed is:

1. A user equipment (UE) for wireless communication, comprising:
at least one memory; and
at least one processor coupled with the at least one memory and configured to cause the UE to:
receive a first configured grant (CG) configuration for an uplink (UL) bandwidth part (BWP); and
receive a second CG configuration for an UL subband,
wherein the first CG configuration and the second CG configuration are received in a first signaling; or
wherein the first CG configuration is received in a second signaling and the second CG configuration is received in a third signaling different from the second signaling.

2. The UE of claim 1, wherein in a case that the first CG configuration and the second CG configuration are received in the first signaling, a type of CG configured by the first CG configuration and a type of CG configured by the second CG configuration are different.

3. The UE of claim 2, wherein the first CG configuration configures a type 1 CG for the UL BWP, and the second CG configuration configures a type 2 CG for the UL subband; and wherein the at least one processor is further configured to cause the UE to:
receive first downlink control information (DCI) for CG activation, wherein the first DCI activates the type 2 CG for the UL subband; or
receive a second DCI for CG deactivation, wherein the second DCI deactivates the type 2 CG for the UL subband.

4. The UE of claim 1, wherein in a case that the first CG configuration and the second CG configuration are received in the first signaling, a type of CG configured by the first CG configuration and a type of CG configured by the second CG configuration are same.

5. The UE of claim 4, wherein:
the first CG configuration configures a type 2 CG for the UL BWP, and the second CG configuration configures a type 2 CG for the UL subband; and
the at least one processor is further configured to cause the UE to receive first downlink control information (DCI) for CG activation,
wherein the first DCI includes an indication indicating to activate the type 2 CG for the UL BWP, the type 2 CG for the UL subband, or both the type 2 CG for the UL BWP and the type 2 CG for the UL BWP, or
wherein a cyclic redundancy check (CRC) of the first DCI is scrambled by a radio network temporary identifier (RNTI), and whether the type 2 CG for the UL BWP or the type 2 CG for the UL subband is activated by the first DCI is determined based on the RNTI; or
the at least one processor is further configured to cause the UE to receive second DCI for CG deactivation,
wherein the second DCI includes an indication indicating to deactivate the type 2 CG for the UL BWP, the type 2 CG for the UL subband, or both the type 2 CG for the UL BWP and the type 2 CG for the UL BWP, or
wherein a CRC of the second DCI is scrambled by an RNTI, and whether the type 2 CG for the UL BWP or the type 2 CG for the UL subband is deactivated by the second DCI is determined based on the RNTI.

6. The UE of claim 2, wherein the first CG configuration configures a type 2 CG for the UL BWP, and the second CG configuration configures a type 1 CG for the UL subband; and wherein the at least one processor is further configured to cause the UE to:
receive first downlink control information (DCI) for CG activation, wherein the first DCI activates the type 2 CG for the UL BWP; or
receive a second DCI for CG deactivation, wherein the second DCI deactivates the type 2 CG for the UL BWP.

7. The UE of claim 1, wherein in a case that the first CG configuration is received in the second signaling and the second CG configuration is received in the third signaling, the first CG configuration is associated with the second CG configuration.

8. The UE of claim 7, wherein an association of the first CG configuration and the second CG configuration is indicated in the third signaling.

9. The UE of claim 7, wherein an association of the first CG configuration and the second CG configuration is based on an index of the first CG configuration and an index of the second CG configuration.

10. The UE of claim 7, wherein the at least one processor is further configured to cause the UE to determine a first set of time units with CG resources for the UL BWP based on the first CG configuration and a second set of time units with CG resources for the UL subband based on the second configuration.

11. The UE of claim 10, wherein in a case that both the first set of time units and the second set of time units include a first time unit:
the at least one processor is further configured to cause the UE to:
determine that CG resources for the UL subband are available for a PUSCH transmission in the first time unit when CG resources for the UL BWP are not within the UL subband in the first time unit; or
determine whether CG resources for the UL subband or CG resources for the UL BWP are available for a PUSCH transmission in the first time unit is configured or preconfigured when CG resources for the UL BWP are within the UL subband in the first time unit.

12. The UE of claim 1, wherein in a case that the first CG configuration is received in the second signaling and the second CG configuration is received in the third signaling, the first CG configuration is not associated with the second CG configuration.

13. The UE of claim 12,
wherein the at least one processor is further configured to cause the UE to determine a time unit based on the first CG configuration, and in a case that the time unit is a downlink (DL) time unit configured with the UL subband, CG resources for the UL BWP determined based on the first configuration are not available in the DL time unit; or
wherein the at least one processor is further configured to cause the UE to determine a time unit based on the second CG configuration, and in a case that the time unit is a UL time unit, CG resources for the UL subband determined based on the second configuration are not available in the UL time unit.

14. A base station (BS) for wireless communication, comprising:
at least one memory; and
at least one processor coupled with the at least one memory and configured to cause the BS to:
transmit, to a user equipment (UE), a first configured grant (CG) configuration for an uplink (UL) bandwidth part (BWP); and
transmit, to the UE, a second CG configuration for an UL subband,
wherein the first CG configuration and the second CG configuration are transmitted in a first signaling; or
wherein the first CG configuration is transmitted in a second signaling and the second CG configuration is transmitted in a third signaling different from the second signaling.

15. A method performed by a user equipment (UE), comprising:
receiving a first configured grant (CG) configuration for an uplink (UL) bandwidth part (BWP); and
receiving a second CG configuration for a UL subband,
wherein the first CG configuration and the second CG configuration are received in a first signaling; or
wherein the first CG configuration is received in a second signaling and the second CG configuration is received in a third signaling different from the second signaling.

16. A processor for wireless communication, comprising:
at least one controller coupled with at least one memory and configured to cause the processor to:
receive a first configured grant (CG) configuration for an uplink (UL) bandwidth part (BWP); and
receive a second CG configuration for an UL subband,
wherein the first CG configuration and the second CG configuration are received in a first signaling; or
wherein the first CG configuration is received in a second signaling and the second CG configuration is received in a third signaling different from the second signaling.

17. The processor of claim 16, wherein in a case that the first CG configuration and the second CG configuration are received in the first signaling, a type of CG configured by the first CG configuration and a type of CG configured by the second CG configuration are different.

18. The processor of claim 17, wherein the first CG configuration configures a type 1 CG for the UL BWP, and the second CG configuration configures a type 2 CG for the UL subband; and wherein the at least one controller is further configured to cause the processor to:
receive first downlink control information (DCI) for CG activation, wherein the first DCI activates the type 2 CG for the UL subband; or
receive a second DCI for CG deactivation, wherein the second DCI deactivates the type 2 CG for the UL subband.

19. The processor of claim 16, wherein in a case that the first CG configuration and the second CG configuration are received in the first signaling, a type of CG configured by the first CG configuration and a type of CG configured by the second CG configuration are same.

20. The processor of claim 17, wherein the first CG configuration configures a type 2 CG for the UL BWP, and the second CG configuration configures a type 1 CG for the UL subband; and wherein the at least one controller is further configured to cause the processor to:
receive first downlink control information (DCI) for CG activation, wherein the first DCI activates the type 2 CG for the UL BWP; or
receive a second DCI for CG deactivation, wherein the second DCI deactivates the type 2 CG for the UL BWP.
